(19) United States
(12) Patent Application Publication
(10) Pub. No.: US 2024/0275875 A1
(43) Pub. Date: Aug. 15, 2024

(54) FOLDABLE-DISPLAY TYPE PORTABLE TERMINAL

(71) Applicants: Sang Kyu RYU, Uiwang-si (KR); Jun Sun RYU, Seoul (KR)

(72) Inventors: Sang Kyu RYU, Uiwang-si (KR); Jun Sun RYU, Seoul (KR)

(21) Appl. No.: 16/980,817

(22) PCT Filed: Mar. 15, 2019
(86) PCT No.: PCT/KR2019/003060

§ 371 Date: Oct. 30, 2023

(30) Foreign Application Priority Data
Mar. 15, 2018 (KR) 10-2018-0029986
Mar. 30, 2018 (KR) 10-2018-0036925
Mar. 13, 2019 (KR) 10-2019-0028910

(51) Int. Cl. H04M 1/02; G06F 3/0354; G06F 3/039; H04M 1/04

(52) U.S. Cl. CPC H04M 1/0268; G06F 3/03545; G06F 3/039; H04M 1/0216; H04M 1/04

(57) ABSTRACT

A foldable-display type portable terminal has a flexible display mounted thereon and can be folded and unfolded by an external force. The portable terminal includes a body having a first panel, an adjacent second panel, and a hinge part between and connecting the first and second panels, permitting the first and second panels to rotate with respect to each other. A flexible display on the upper surface of the body folds with the first and second panels when the first and second panels are folded about the hinge part. In one alternative, a support member beneath the flexible display covers the upper part of the hinge part and supports the lower part of the flexible display. In another alternative, a support rotatably installed at the body is arranged inside the body and folded at the upper part of the flexible display when the first and second panels are folded.

### FIELD OF INVENTION

The present invention relates to a foldable-display type portable terminal and, more particularly, to a foldable-display type portable terminal in which a flexible display is folded or unfolded by external force.

### BACKGROUND OF INVENTION

In general, a flexible display panel is a display panel that can be bent at a predetermined curvature.

Since the flexible display panel uses a plastic substrate rather than a commonly used glass substrate, a low temperature manufacturing processis mainly used in order to prevent damage the substrate, instead of a conventional manufacturing process.

The flexible display panel is manufactured as, for example, a touchscreen enabling capacitive or resistive touch input so as to receive a user's command in a touch manner.

On the other hand, the conventional portable foldable display device, that is, a foldable type portable terminal, is provided with a flexible display panel enabling touch input as described above.

Such a conventional foldable type portable terminal forms a predetermined accommodation space in which a folded portion of the flexible display panel may be bent in a curved form at a portion where a pair of bodies supporting the flexible display panel is hinged to each other.

A variety of hinge modules for opening and closing the flexible display is currently being developed, but in the case of a folder provided with the flexible display, due toa difference between an inner diameter and an outer diameter of a hinge shaft constituting the hinge part according totypes and elasticity of the flexible display, problems such as distance and area mismatch between the main body and the flexible display may arise.

In particular, a structure of the hinge part for folding the flexible display to stably support the flexible display uponfolding, unfolding or touching is complicated and thick, in addition, problems such as wrinkles on the flexible display or mis-spreading of the flexible display may arise when spreading the folded flexible display.

### SUMMARY OF INVENTION

### Technical Problem to be Solved

The present disclosure has been proposed to overcomethe aforementioned problems, and an object of the present disclosure is to providea foldable-display type portable terminal, including a hinge part with a simple and thin structure for folding a flexible display in order to stably support the flexible display, whereby the flexible display is easy to touch and, when spreading the folded flexible display, the flexible display can maintain a flatly spreadstate without occurrence of wrinkles on the flexible display or mis-spreading of the flexible display, and may be folded or multi-folded.

### Technical Solution

In order to achieve the above object, the foldable-display type portable terminal of the present invention is provided with a flexible display mounted to be folded and unfolded by external force, and may include: amain body which includes a first panel, a second panel disposed adjacent to the first panel, and a hinge part disposed between the first panel and the second panel to rotatably connect the first panel and the second panel to each other; a flexible display disposed on a top surface of the main body, which is folded when first panel and the second panel are folded around the hinge part; and a support member disposed under the flexible display while covering an upper portion of the hinge part, so as to support the bottom of the flexible display.

The support member may include a leaf spring disposed at the upper portion of the hinge partin which one end is connected to the first panel and the other end is connected to the second panel.

The leaf spring may support the bottom of the flexible display when the flexible display is pressed.

The hinge part may include a rotary space to rotate the first panel and the second panel, the leaf spring may be arranged to cover an upper portion of the rotary space, and the flexible display may be supported by the leaf spring disposed therebelow when pressed on the upper portion of the rotary space.

The hinge part may include at least two shafts, the leaf spring may be arranged to cover a spaced portion formed between the plural shafts, and the flexible display may be supported by the leaf spring disposed therebelow when pressed on top of the spaced portion.

When the first and second panels are folded around the hinge part, the leaf spring and the flexible display are also folded, wherein the leaf spring is curved in an arc shape to guide the flexible display disposed thereon to be smoothly bent in an arc shape while supporting the same.

The leaf spring and the flexible display may be folded together inward or outward.

The leaf spring may be formed in a strip type arranged in a length direction in which the first panel and the second panel are disposed, wherein a plurality of leaf springs isprovided and connected to the first panel and the second panel.

The leaf spring may be disposed to move relative to the first panel or the second panel.

The main body may be formed by connecting a plurality of the first panels, the second panels and the hinge parts, and the main body may be multi-folded in a state in which the plurality of the first panels, the second panels and the hinge parts are connected, thereby forming a wearable ring.

The main body constituting a closed loop type ring may be unfolded or spread in an open loop shape by separating any one part thereof.

The hinge part may be formed of a spring.

At this time, the hinge part is embedded in an elastic material such as rubber, silicone, etc.

Further, in order to achieve the above object, the foldable-display type portable terminal of the present invention is provided with a flexible display mounted to be folded and unfolded by external force, and may include: a main body which includes a first panel, a second panel disposed adjacent to the first panel, and a hinge part disposed between the first panel and the second panel to rotatably connect the first panel and the second panel to each other; a flexible display disposed on a top surface of the main body, which is folded when the first panel and the second panel are folded around the hinge part; and an elastic pad disposed cider the flexible display while covering an upper portion of the main body so as to support the bottom of the flexible display.

The flexible display may be mounted on the elastic pad to be movable in a horizontal direction independently of the elastic pad.

Further, in order to achieve the above object, the foldable-display type portable terminal of the present invention is provided with a flexible display mounted to be folded and unfolded by external force, and may include: a main body which includes first panel, a second panel disposed adjacent to the first panel, and a hinge part disposed between the first panel and the second panel to rotatably connect the first panel and the second panel to each other; a flexible display disposed on a top surface of the main body, which is folded when the first panel and the second panel are folded around the hinge part; and a support rotatably mounted to the main body and disposed inside the main body which is folded on an upper portion of the flexible display when the first and second panels are folded around the hinge part.

The support may be rotatably hinged to the first panel or the second panel at one end thereof, wherein, when the main body is folded in a state in which the support rotates and is disposed on top of the first panel or the second panel, the support is located between the first panel and the second panel on top of the flexible display.

The support is rotatable coupled to one side of the hinge part that is located in a direction (Y-axis direction) orthogonal to a direction in which the first panel and the second panel are disposed (X-axis direction), wherein, when the main body is folded in a state in which the support rotates and is disposed on top of the hinge part in the Y-axis direction, the support is located inside the hinge part bent at the upper portion of the flexible display.

The support may include a holder part rotatably hinged to one side of the hinge part, and a touch pen detachably coupled to the holder part.

The support may include a holder part rotatably hinged to one side of the hinge part, and a portable terminal accessory may be detachably equipped in the holder part.

The support rotates in a direction opposite to the flexible display to support the main body inclined with respect to the ground.

### EFFECT OF INVENTION

As described above, the foldable-display type portable terminal of the present invention has the following advantages.

The present invention can stably support the flexible display in which the support member is folded, maintain the flexile display flatly spreading without wrinkles when the flexible display is unfolded, and allow easy and sensible touching when the flexible display is touched.

Especially, even if a structure of the hinge part folded by the support member is not complex but simply manufactured, the support member can support the bottom of the flexible display and perform smooth touchinqof the flexible display without being curved or bent when pressing the flexible display by touching or the like.

In addition, since the hinge part has a large thickness because of the support member hinged to the main body, if an empty space occurs between the first panel and the second panel or inside the hinge part when folding the hinge part, the support (an auxiliary battery, touch pen, etc.) is located in the empty space to thus improve space utility. Further, since the empty space is filled with the support when external force is applied or upondropping, it is possible to prevent the first panel and the second panel spaced apart from each other from being pressed or pushed into the empty space formed inside the hinge part, thereby protecting the panels without damage.

In addition, the support rotates in the opposite direction tothe flexible display and may serve as a cradle for supporting the main body inclined with respect to the ground.

### BRIEF DESCRIPTION OF DRAWINGS

FIG. 1 is a perspective view of a foldable-display type portable terminal according to a first embodiment of the present invention.

FIG. 2 is an exploded perspective view of the foldable-display type portable terminal according to the first embodiment of the present invention.

FIG. 3 is a cross-sectional view taken along line A-A shown in FIG. 1.

FIG. 4 is a cross-sectional view of the foldable-display type portable terminal of FIG. 3 in a folded state.

FIG. 5 is a cross-sectional view of a foldable-display type portable terminal according to a second embodiment of the present invention.

FIG. 6 is a cross-sectional view of the foldable-display type portable terminal of FIG. 5 in a folded state.

FIG. 7 is a perspective view of a foldable-display type portable terminal according to a third embodiment of the present invention.

FIG. 8 illustratesa folding process of thefoldable-display typeportable terminal according to the third embodiment of the present invention.

FIG. 9 is a perspective view of a foldable-display type portable terminal according to a fourth embodiment of the present invention.

FIG. 10 illustrates a folding processof thefoldable-display typeportable terminal according to the fourth embodiment of the present invention.

FIG. 11 is a side view of thefoldable-display typeportable terminal according to the fourth embodiment of the present invention in a state in which the terminal is held on a cradle.

### DETAILED DESCRIPTION OF PREFERRED EMBODIMENTS OF INVENTION

### First Embodiment

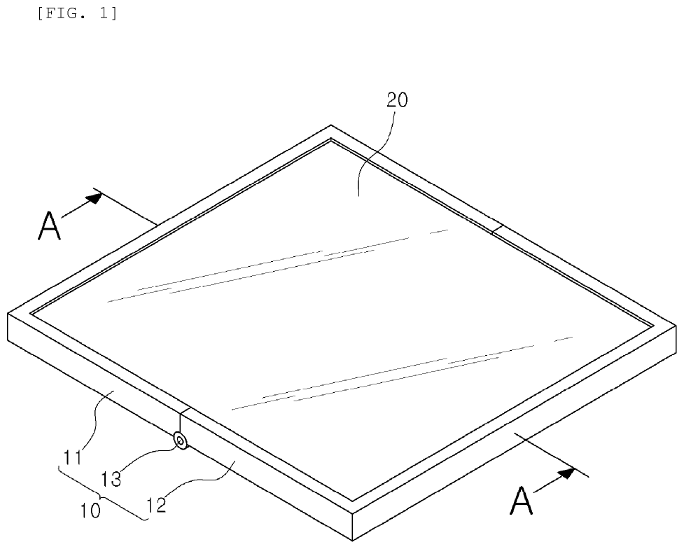

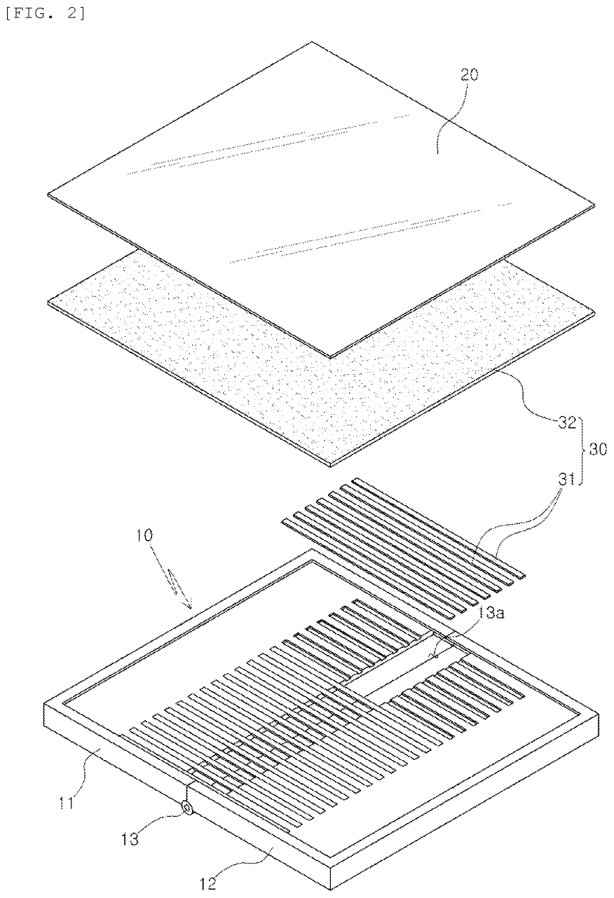

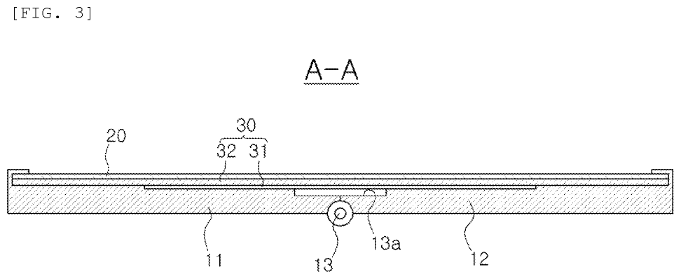

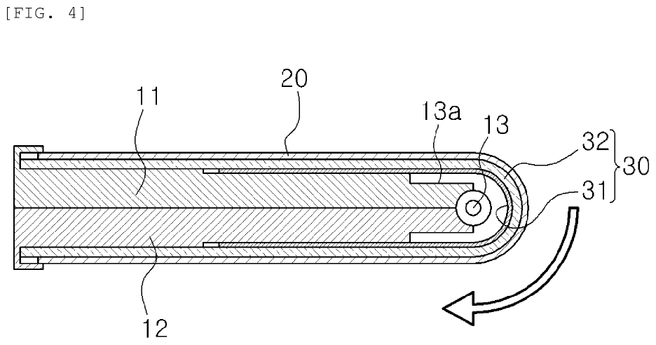

FIG. 1 is a perspective view of a foldable-display type portable terminal according to a first embodiment of the present invention; FIG. 2 is an exploded perspective view of the foldable-display type portable terminal according to the first embodiment of the present invention; FIG. 3 is a cross-sectional view taken along line A-A shown in FIG. 1; FIG. 4 is a cross-sectional view of the foldable-display type portable terminal of FIG. 3 in a folded state.

The foldable-display type portable terminal of the present invention may include a main body 10, a flexible display 20 and a support member 30, wherein the flexible display 20 is mounted to be folded and unfolded by external force.

The main body 10 includes a first panel 11, a second panel 12, and a hinge part 13.

The first panel 11 and the second panel 12 are disposed adjacent to each other.

The hinge part 13 is disposed between the first panel 11 and the second panel 12 andmay connect the first panel 11 and the second panel 12 to rotate each other.

Although a single first panel 11, a second panel 12 and a single hinge part 13 are respectively shown in the drawings of the present exemplary embodiment, a plurality of first panels 11, second panels 12 and hinge parts 13, respectively, may also be provided as necessary.

The plural first panels 11 andsecond panels 12 may be provided, and such first panels 11 and second panels 12 may be connected to each other by a plurality of hinge parts 13 to perform multiple folding. As a result, the main body 10 may have a wearable ring shape, like a watch.

Further, the main body 10 constituting a closed loop type ring shape through mutual connection may be spread in an open loop shape.

In this case, a separate locking member may be mounted on the main body 10 to form a structure in which both ends of the spreading main body 10 are detachably coupled to each other.

Although not shown in the drawings, as described above, using such a multi-folding structure wherein the main body 10 is bent several times may manufacture a wearable type portable terminal worn on a wrist. Further, a folding configuration at a specific point in the multi-folding structure may be fabricated to rotate at 180 degrees and utilized to switch a ring type portable terminal to a folding type portable terminal or vice versa.

Further, the main body 10 may be folded in different manners according to a bending direction of the hinge part 13.

According to the present embodiment, the hinge part 13 consists of one shaft, wherein a rotary space13a to rotate the first panel 11 and the second panel 12 is formed.

The rotary space 13a is formed concave or stepped.

Further, the hinge part 13 may be made of a spring material such as a ring spring or a leaf spring.

The hinge part13 made of a spring material is preferably inserted into an elastic material such as rubber, silicone, fiber, and the like, thus not being exposed to the outside.

The flexible display 20 is disposed on a top surface of the main body 10 and, as shown in FIG. 4, may be folded when the first panel 11 and the second panel 12 are folded around the hinge part 13.

The support member 30 is disposed under the flexible display 20 while covering at least an upper portion of the hinge part 13.

The support member 30 may cover only the hinge part 13 or both upper portions of the first panel 11 and the second panel 12.

As described, the support member 30 is disposed under the flexible display 20 to support the bottom of the flexible display 20.

In this embodiment, the support member 30 is composed

of a leaf spring 31 and the elastic pad 32.

The leaf spring 31 is disposed above the hinge part 13, wherein one end of the leaf spring 31 is connected to the first panel 11 and the other end is connected to the second panel 12.

More specifically, the leaf spring 31 is arranged to cover an upper portion of the rotary space 13a.

Because of the leaf spring 31, when the flexible display 20 is pressed by external force such as touching or the like on the upper portion of the rotary space 13a in a state in which the flexible display 20 is spread, the leaf spring 31 located on the upper portion of the rotary space 13a may support the bottom of the flexible display 20.

As a result, as shown in FIG. 3, the flexible display 20 does not enter the rotary space13a in a groove form but is supported by the leaf spring 31, thereby enabling the flexible display 20 to be stably touched.

In other words, the flexible display 20 disposed on the upper portion of the rotary space 13a is spaced apart in the upward direction of the rotary space 13a, and the leaf spring 31 is disposed therebetween to support the bottom of the flexible display 20. Therefore, even if the flexible display 20 is pressed on the upper portion of the rotary space 13a, the flexible display 20 is not recessed into the rotary space 13a but is supported by the leaf spring 31, thereby enabling the flexible display 20 to be stably touched.

Further, as shown in FIG. 4, when the first panel 11 and the second panel 12 are folded around the hinge part 13, the leaf spring 31 and the flexible display 20 are also folded, wherein the leaf spring 31 is bent in an arc shape and supports the flexible display 20 arranged thereon while guiding the same to be smoothly curved or bent in an arc shape.

The leaf spring 31 is bent to form a curved shape on the upper portion of the hinge part 13 when the first panel 11 and the second panel 12 are folded, so that the flexible display 20 may be supported while being smoothly curved in an arc shape by the leaf spring 31.

The leaf spring 31 and the flexible display 20 may be folded inward or outward of the main body 10 according to an installation position thereof.

In the drawing of the present embodiment, the leaf spring 31 and the flexible display 20 are shown as an out-folding type that is folded outward.

The leaf spring 31 may be mounted in a single wide plate shape or may be mounted as a plurality of strip type springs as shown in the drawing of the present embodiment.

In the drawing of the present embodiment, the leaf spring 31 consists of a strip type spring longitudinally disposed in a direction in which the first panel 11 and the second panel 12 are arranged, wherein the leaf spring 31 comprises a plurality of strings to which the first panel 11 and the second panel 12 are connected.

Since the leaf spring 31 comprises a plurality of strip type springs rather than a wide plate, elastic restoration force applied to the main body 10 by the leaf spring 31 when folding the main body 10 may be reduced.

If spreading force strongly actsonthe main body 10 by the leaf spring 31 when the main body 10 is in a folded state, a separate locking member may be further mounted on the main body 10 to maintain the main body 10 in the folded state.

The leaf spring 31 may be fixedly connected to the first panel 11 and the second panel 12. Preferably, the leaf spring 31 is arranged to be movable with respect to the first panel 11 and/or the second panel 12.

In fact, the leaf spring 31 is bent when folding the main body 10. However, if both ends of the leaf spring 31 are fixed to the first panel 11 and the second panel 12, respectively, the leaf spring 31 may not be smoothly curved or bent in an arc shape due to a distance difference between a rotational center point of the hinge part 13 and the leaf spring 31.

However, when the leaf spring 31 is mounted to be movable in a longitudinal direction with respect to the first panel 11 and/or the second panel 12, the leaf spring 31 may slide when folding the main body 10, and therefore, may be smoothly curved or bent in an arc shape. Accordingly, the flexible display 20 may be stably supported without damage.

The elastic pad 32 is made of a material such as rubber, plastic, fiber, composite material, etc., and is disposed underthe flexible display 20 while covering anupper portion of the main body 10.

More specifically, the elastic pad 32 is disposed under the flexible display 20 on top of the leaf spring 31.

The elastic pad 32 may convert a non-flat surface due to a structure of the main body 10 and the leaf spring 31 into a flat state, so that the bottom of the flexible display 20 disposed thereon is in contact with the flat surface of the elastic pad 32 to be supported thereon.

The elastic pad 32 may have different patterns and hole shapes.

The elastic pad 32 may include sheets.

The elastic pad 32 may be integrated with the flexible display 20. However, since a defect rate and unit cost are likely to increase in a display manufacturing process and, for convenience in replacement of components, the elastic pad 32 is preferably provided as a separate part (that is, independent of the flexible display 20).

Further, the elastic pad 32 may act as a buffer to absorb force uponexternal impact to protect the main body 10 or the flexible display 20, and may fill a gap present in the main body 10 to contribute to screen flattening of the flexible display 20.

In addition, the leaf spring 31 exhibits a cushioning effect along with the elastic pad 32 when the portable terminal is dropped, thereby reducing damage to the portable terminal.

On the other hand, the flexible display 20 is mounted to be movable on an upper portion of the elastic pad 32 in a horizontal direction independently of the elastic pad 32.

Further, separate springs may be provided on both sides of the flexible display 20 so that the flexible display 20 can be restored to its original position when the flexible display 20 is moved in the horizontal direction.

As such, since the flexible display 20 is mounted to be movable in the horizontal direction with respect to the elastic pad 32, the flexible display 20 may move along a folding angle when the main body 10 is folded so as to prevent both ends of the flexible display 20 in a fixed state from being broken. Further, it is possible to prevent occurrence of wrinkles in a portion at which the flexible display 20 is fixed when spreading the main body 10, thereby maintaining the flexible display 20 in a flatly spread state.

The present embodiment has described that the support member 30 consists of the leaf spring 31 and the elastic pad 32, however, the support member 30 may also comprise only the leaf spring 31 or only the elastic pad 32.

As described above, the present invention may stably support the folded flexible display, maintain the same in a flatly spread state without wrinkles when unfolding the flexible display 20, and enable the flexible display 20 to be easily and sensibly touched when touching the same.

In particular, even if the structure of the hinge partfolded by the support member 30 is not complicated but simply configured, the support member 30 may support the bottom of the flexible display 20 and, in addition, when pressing the flexible display 20 by touching or the like, may enable smooth touch operation on the flexible display 20 without bending.

### Second Embodiment

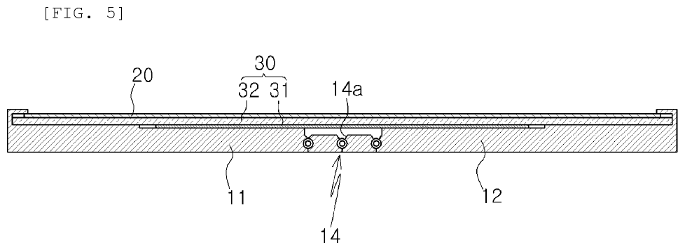

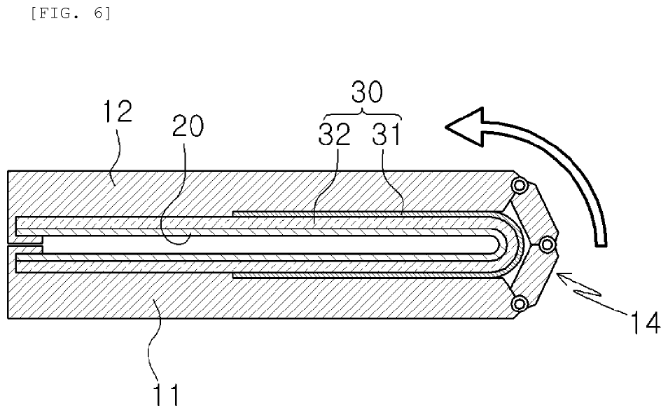

FIG. 5 is a cross-sectional view of afoldable-display typeportable terminal according to a second embodiment of the present invention, and FIG. 6 is a cross-sectional view of the foldable-display typeportable terminal of FIG. 5 in a folded state.

The second embodiment has a difference in the hinge part14 as compared with the first embodiment, which will be described in detail below.

In order to smoothly fold the main body 10 inward and/or outward, as shown in FIG. 5 and FIG. 6, the hinge part 14 comprises at least two shafts.

A structure of the hinge part 14 comprising two or more shafts may be sufficiently embodied using conventionalwell-known structures, and therefore, a detailed description thereof will be omitted.

The hinge part 14 comprising a plurality of shafts may include a spaced portion 14a formed between the plural shafts.

The leaf spring 31 may be arranged while covering the spaced portion 14a formed between the plural shafts.

Therefore, in a state in which the flexible display 20 is spread, when the flexible display 20 is pressed on top of the spaced portion 14a, the bottom of the flexible display 20 may be supported by the leaf spring 31 in order to prevent the flexible display 20 from being recessed into a groove in which the spaced portion 14a is formed.

Because of the leaf spring 31, even if the hinge part 14 comprising two or more shafts has a simple structure, the support member 30 may stably support the flexible display 20.

Since other matters are substantially identical or similar to the first embodiment, a detailed description thereof will be omitted.

### Third Embodiment

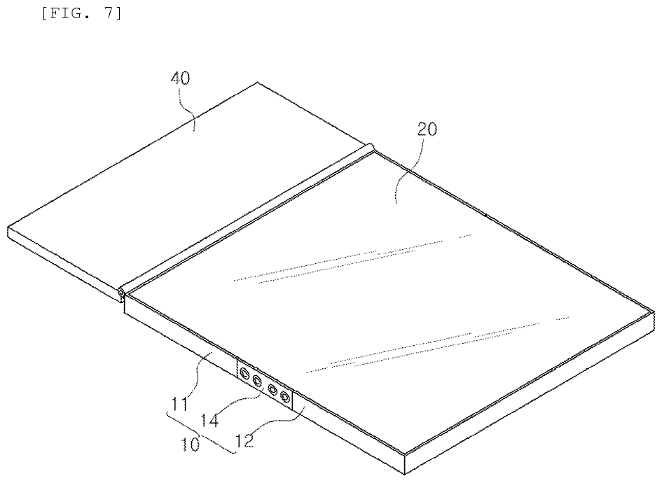

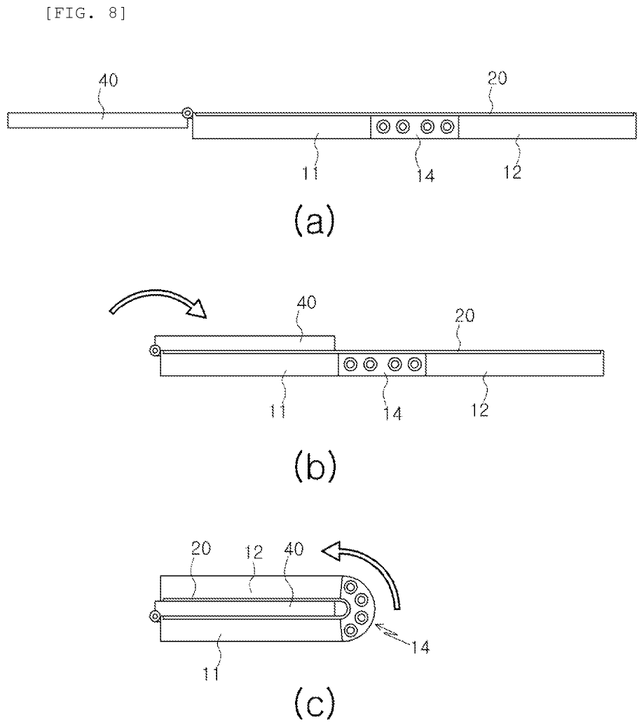

FIG. 7 is a perspective view of a foldable-display type portable terminal according to a third embodiment of the present invention, and FIG. 8 illustrates a folding process of the foldable-display type portable terminal according to the third embodiment of the present invention.

As illustrated in FIG. 7 and FIG. 8, the foldable-display type portable terminal of the present invention includes a main body 10, a flexible display 20, a hinge part 14 and a support 40.

Since the main body 10, the flexible display 20 and the hinge part 14 are substantially the same as the above-described first and/or second embodiments, a detailed description thereof will be omitted.

The support 40 is rotatably mounted to the main body and, when the first panel 11 and the second panel 12 rotate and are and folded around the hinge part 14, is disposed on the inside of the main body 10 folded on top of the flexible display 20.

More specifically, the support 40 may have a cross section of differentshapes such as flat plate, elliptical, balloon shape, etc., one end of which is rotatably hinged to the first panel 11 or the second panel 12.

The support 40 may comprise an auxiliary battery or the like.

In a spread state as shown in FIG. 8(a), after rotating the support 40to be disposed above the first panel 11 or the second panel 12 as shown in FIG. 8(b), when the main body 10 is folded as shown in FIG. 8(c), the support 40 is disposed between the first panel 11 and the second panel on top of the flexible display 20.

Therefore, if an empty space occurs between the first panel 11 and the second panel 12 due to a large thickness of the hinge part 14 when folding the hinge part 14, the support 40 such as an auxiliary battery may be disposed in the empty space, thereby improving space utility. Further, since the empty space is filled with the support 40, it is possible to prevent the first panel 11 and the second panel spaced from each other from being damaged or pressed into the empty space when external force is applied or the portable terminal is dropped.

In order to prevent damage caused by impact, an elastic plate such as rubber may be provided on the support 40.

If the support 40 is arranged between the first panel 11 and the second panel 12 to fill the empty space, the support 40 may be formed in different shapes than the above-described shape.

In the present embodiment, the configuration (support member) of the first embodiment or the second embodiment may be further added.

### Fourth Embodiment

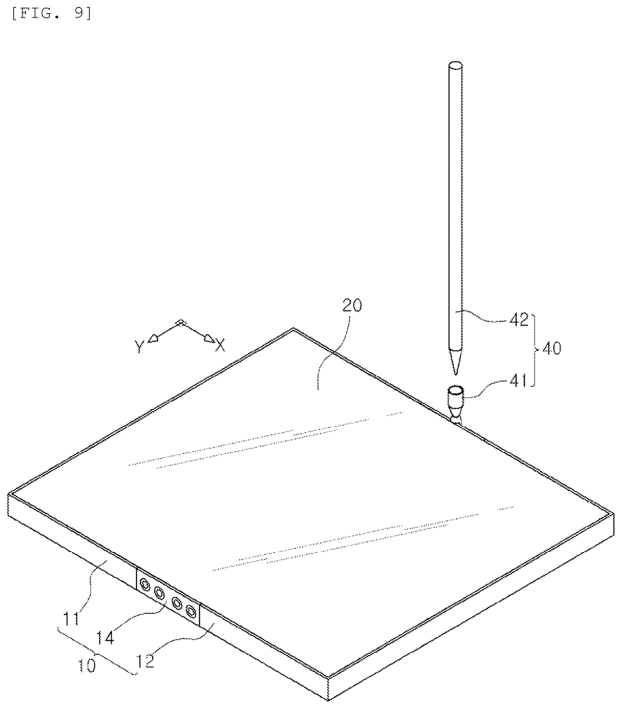

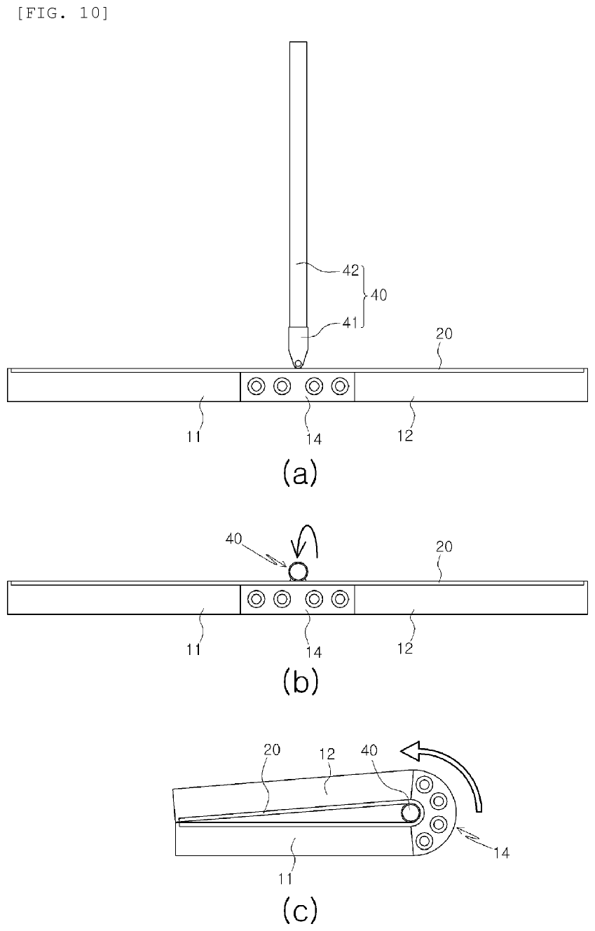

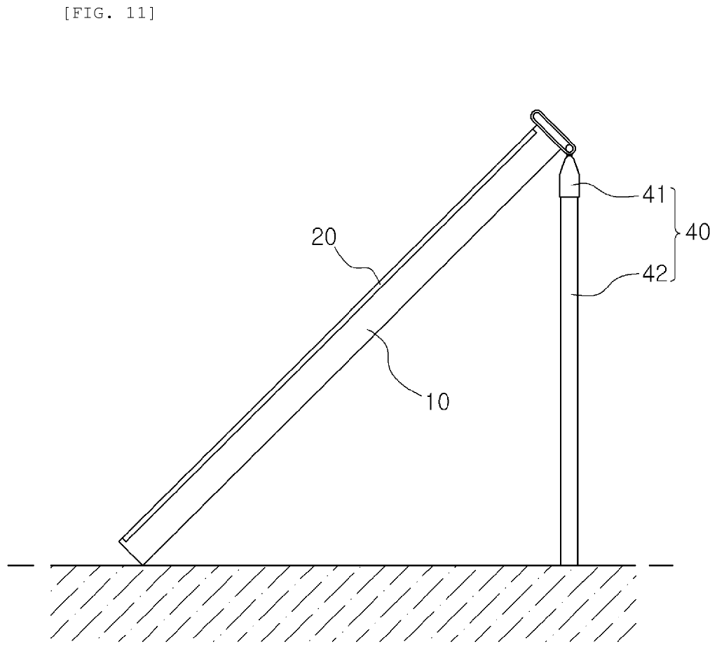

FIG. 9 is a perspective view of a foldable-display type portable terminal according to a fourth embodiment of the present invention, FIG. 10 illustrates a folding process of the foldable-display typeportable terminal according to the fourth embodiment of the present invention, and FIG. 11 is a side view of thefoldable-display type portable terminal according to the fourth embodiment in a state in which the terminal is held on a cradle.

The fourth embodiment has a difference in the support, compared to the third embodiment, which will be described in detail below.

The support 40 is formed in a rod shape and rotatably coupled to one side of the hinge part 14 arranged in a direction (Y-axis direction) orthogonal to a direction in which the first panel 11 and the second panel 12 are disposed (X-direction).

In this case, the support 40 may be formed in a plate shape other than the rod shape.

The support 40 may be rotatably coupled to the Y-axis direction only at one side of the hinge part 14, or may be rotatably coupled to different directions including the Y-axis direction in a coupling manner such as a ball joint.

After rotating the support 40 as shown in FIG. 10(b) in the spreadstate as shown in FIG. 10(a) to locate the same in the Y-axis direction on top of the hinge part 14, the support 40 may be disposed on the inside of a hinge part 14 bent on top of the flexible display 20 by folding the main body 10 as shown in FIG. 10(c).

Accordingly, if an empty space occurs inside the hinge 14 due to a large thickness of the hinge part 14 when folding the hinge part 14, the support 40 in a rod shape may be disposed in the empty space, thereby improving space utility. Further, since the empty space formed inside the hinge part 14 is filled with the support 40, it is possible to prevent the hinge part 14 from being pressed into the empty space and being broken when external force is applied or the portable terminal is dropped.

The support 40 may be made of a simple rod. However, as in the present embodiment, the support 40 includes a holder part 41 rotatably hinged to one side of the hinge part 14 and a touch pen 42 detachably coupled to the holder part 41.

Accordingly, the flexible display 20 may be touchedusing the touch pen 42 and, when the main body 10 is folded, the flexible display 20 may be disposed in a space formed inside the hinge part 14 to improve space utility or the main body 10 may be prevented from being pressed and broken by external force.

Further, the support 40 may include a holder part 41 rotatably hinged to one side of the hinge part 14, and a portable terminal accessory (connector, earphones, etc.) may be detachably embedded inside the holder part 41.

At this time, the holder part 41 is formed longer than shown in FIG. 9 and FIG. 10 so that accessories for the portable terminal such as earphones can be stored therein.

On the other hand, the support 40 may also rotate in the opposite direction of the flexible display 20 in addition to the upper portion of the flexible display 20, in order to serve as a cradle to support the main body 10 inclined with respect to the ground as shown in FIG. 11.

At this time, the support 40 preferably has a configuration of being adjusted at different angles and then being fixed, so as to move in the opposite direction of the flexible display 20 and support the main body 10.

In FIG. 11, the support 40 vertically stands to support the main body 10. However, when the support 40 has a structure known in the art such that the support is adjusted at a predetermined angle and then maintains the angle, the support 40 may support the main body 10 in an inclined state while being in contact with the ground as a whole in a length direction.

In this embodiment, the configuration (support member) of the first embodiment or the second embodiment may be further added.

The foldable-display typeportable terminal of the present invention is not limited to the aforementioned embodiments, but may be implemented in various modifications within the technical spirit of the present invention.

### INDUSTRIAL APPLICABILITY

The display of the present invention, which has industrial applicability, can be used for folding type portable terminals (mobile devices, smartphones, etc.).

1. A foldable-display type portable terminal provided with a flexible display mounted to be folded and unfolded by external force, comprising:
a main body which includes a first panel, a second panel disposed adjacent to the first panel, and a hinge part disposed between the first panel and the second panel to rotatably connect the first panel and the second panel to each other;
a flexible display disposed on a top surface of the main body, which is folded when the first panel and the second panel are folded around the hinge part; and
a support member disposed under the flexible display while covering an upper portion of the hinge part, so as to support the bottom of the flexible display.

2. The portable terminal according to claim 1, wherein the support member includes a leaf spring disposed at the upper portion of the hinge part, in which one end is connected to the first panel and the other end is connected to the second panel.

3. The portable terminal according to claim 2, wherein the leaf spring supports the bottom of the flexible display when the flexible display is pressed.

4. The portable terminal according to claim 3, wherein:
the hinge part includes a rotary space to rotate the first panel and the second panel,
the leaf spring is arranged to cover an upper portion of the rotary space, and
the flexible display is supported by the leaf spring disposed therebelow when pressed on the upper portion of the rotary space.

5. The portable terminal according to claim 3, wherein:
the hinge part includes at least two shafts,
the leaf spring is arranged to cover a spaced portion formed between the at least two shafts, and
the flexible display is supported by the leaf spring disposed therebelow when pressed on top of the spaced portion.

6. The portable terminal according to claim 2, wherein:
when the first and second panels are folded around the hinge part, the leaf spring and the flexible display are also folded, and
the leaf spring is curved in an arc shape to guide the flexible display disposed thereon to be smoothly bent in an arc shape while supporting the same.

7. The portable terminal according to claim 2, wherein the leaf spring and the flexible display are folded together inward or outward.

8. The portable terminal according to claim 2, wherein:
the leaf spring is formed in a strip type arranged in a length direction in which the first panel and the second panel are disposed; and
a plurality of leaf springs is provided and connected to the first panel and the second panel.

9. The portable terminal according to claim 2, wherein the leaf spring is disposed to move relative to the first panel or the second panel.

10. The portable terminal according to claim 1, wherein:
the main body is formed by connecting a plurality of the first panels, the second panels and the hinge parts, and
the main body is multi-folded in a state in Which the plurality of the first panels, the second panels and the hinge parts is connected, thereby forming a wearable ring.

11. The portable terminal according to claim 10, wherein the main body constituting a closed loop type ring is unfolded or spread in an open loop shape by separating any one part thereof.

12. The portable terminal according to claim 1, wherein the hinge part is formed a spring.

13. The portable terminal according to claim 1, wherein the hinge part is embedded in an elastic material.

14. A foldable-display type portable terminal provided with a flexible display mounted to be folded and unfolded by external force, comprising:
a main body which includes a first panel, a second panel disposed adjacent to the first panel, and a hinge part disposed between the first panel and the second panel to rotatably connect the first panel and the second panel to each other;
a flexible display disposed on a top surface of the main body, which is folded when the first panel and the second panel are folded around the hinge part; and
an elastic pad disposed under the flexible display while covering an upper portion of the main body so as to support the bottom of the flexible display.

15. The portable terminal according to claim 14, wherein the flexible display is mounted on the elastic pad to be movable in a horizontal direction independently of the elastic pad.

16. A foldable-display type portable terminal provided with a flexible display mounted to be folded and unfolded by external force, comprising:
a main body which includes a first panel, a second panel disposed adjacent to the first panel, and a hinge part disposed between the first panel and the second panel to rotatably connect the first panel and the second panel to each other;
a flexible display disposed on a top surface of the main body, which is folded when the first panel and the second panel are folded around the hinge part; and
a support rotatably mounted to the main body and disposed inside the main body which is folded on an upper portion of the flexible display when the first and second panels are folded around the hinge part.

17. The portable terminal according to claim 16, wherein:
the support is rotatably hinged to the first panel or the second panel at one end thereof, and
when the main body is folded in a state in which the support rotates and is disposed on top of the first panel or the second panel, the support. is located between the first panel and the second panel on top of the flexible display.

18. The portable terminal according to claim 16, wherein:
the support is rotatably coupled to one side of the hinge part that is located in a direction (Y-axis direction) orthogonal to a direction in which the first panel and the second panel are disposed (X-axis direction), and
when the main body is folded in a state in which the support rotates and is disposed on top of the hinge part in the Y-axis direction, the support is located inside the hinge part bent at the upper portion of the flexible display.

19. The portable terminal according to claim 18, wherein the support includes:
a holder part rotatably hinged to one side of the hinge part; and
a touch pen detachably coupled to the holder part.

20. The portable terminal according to claim 18, wherein:
the support includes a holder part rotatably hinged to one side of the hinge part, and
a portable terminal accessory is detachaby equipped in the holder part.

21. The portable terminal according to claim 18, wherein the support rotates in a direction opposite to the flexible display to support the main body inclined with respect to the ground.
